(19) United States
(12) Patent Application Publication
(10) Pub. No.: US 2003/0172118 A1
(43) Pub. Date: Sep. 11, 2003

(54) Method and apparatus for providing post office protocol 3 support for limited storage devices

(75) Inventors: Mark Alan Bilansky, Cedar Park, TX (US); David Stuart Klein, Georgetown, TX (US); Diana Marie McGovern, Cedar Park, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 10/091,265

(22) Filed: Mar. 5, 2002

(51) Int. Cl. G06F 15/16

(52) U.S. Cl. 709/206; 709/203

(57) ABSTRACT

A method, apparatus, and computer instructions for managing electronic mail messages from a post office protocol 3 server. Header information for electronic messages is retrieved on the post office protocol 3 server to form retrieved header information. An attribute file is updated in which the attribute file includes an indication of whether an electronic mail message has been read. The attribute file contains attributes on a per message basis in a preferred embodiment of the present invention. A mail list is presented on a display using the retrieved header information and the attribute file. Responsive to a selection of an electronic mail message from the mail list, the electronic mail message is retrieved and presented.

### BACKGROUND OF THE INVENTION

1. Technical Field

The present invention relates generally to an improved data processing system, and in particular, to a method and apparatus for processing electronic messages. Still more particularly, the present invention provides a method and apparatus for processing electronic messages using a post office protocol 3 server.

2. Description of Related Art

The Internet, also referred to as an “internetwork”, is a set of computer networks, possibly dissimilar, joined together by means of gateways that handle data transfer and the conversion of messages from a protocol of the sending network to a protocol used by the receiving network. When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

Access to the Internet is not limited to computers, but other devices also access the Internet. Pervasive Internet devices include devices, such as personal digital assistants, digital phones, auto PCs, and the like. In the arena of pervasive, limited storage Internet devices, the mail protocol of choice has been Internet messaging access protocol (IMAP) due to the ability to keep and store electronic mail on the server. Post office protocol 3(POP3) has either been overlooked or severely constrained because this protocol depends on the local storage of the client to store electronic mail messages. In addition, POP3's standard practice of deleting mail at the server prohibits the mail from being accessed through multiple pervasive devices, which is an important goal of the pervasive computing strategy. POP3 was architected to be used in a way that normally retrieves mail from the server, deletes it, and stores it locally on the client system. However, due to the high availability of POP3 mail servers that could be employed by these devices, it would be advantageous to have an improved method, apparatus, and computer instructions to provide POP3 support and implement this support in a way that minimizes these limitations.

### SUMMARY OF THE INVENTION

The present invention provides a method, apparatus, and computer instructions for managing electronic mail messages from a post office protocol 3 server. Header information for electronic messages is retrieved on the post office protocol 3 server to form retrieved header information. An attribute file is updated in which the attribute file includes an indication of whether an electronic mail message has been read. The attribute file contains attributes on a per message basis in a preferred embodiment of the present invention. A mail list is presented on a display using the retrieved header information and the attribute file. Responsive to a selection of an electronic mail message from the mail list, the electronic mail message is retrieved and presented.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server, in accordance with a preferred embodiment of the present invention;

FIG. 3 is a block diagram illustrating a data processing system in which the present invention may be implemented;

FIG. 4 is a block diagram of a personal digitial assistant (PDA) is shown in accordance with a preferred embodiment of the present invention;

FIG. 5 is a diagram of a known Internet messaging access protocol (IMAP) system;

FIG. 6 is a diagram illustrating a known POP3 electronic mail system;

FIG. 7 is a diagram of an improved post office protocol 3 (POP3) electronic mail system in accordance with a preferred embodiment of the present invention;

FIG. 8 is a diagram of an entry in a mail attribute file in accordance with a preferred embodiment of the present invention;

FIG. 9 is a flowchart of a process used for retrieving electronic mail messages in accordance with a preferred embodiment of the present invention; and

FIG. 10 is a flowchart of a process used for updating a mail attribute file in accordance with a preferred embodiment of the present invention.

### DETAILED DESCRIPTION OF THE PREFERRED EMBODIMENT

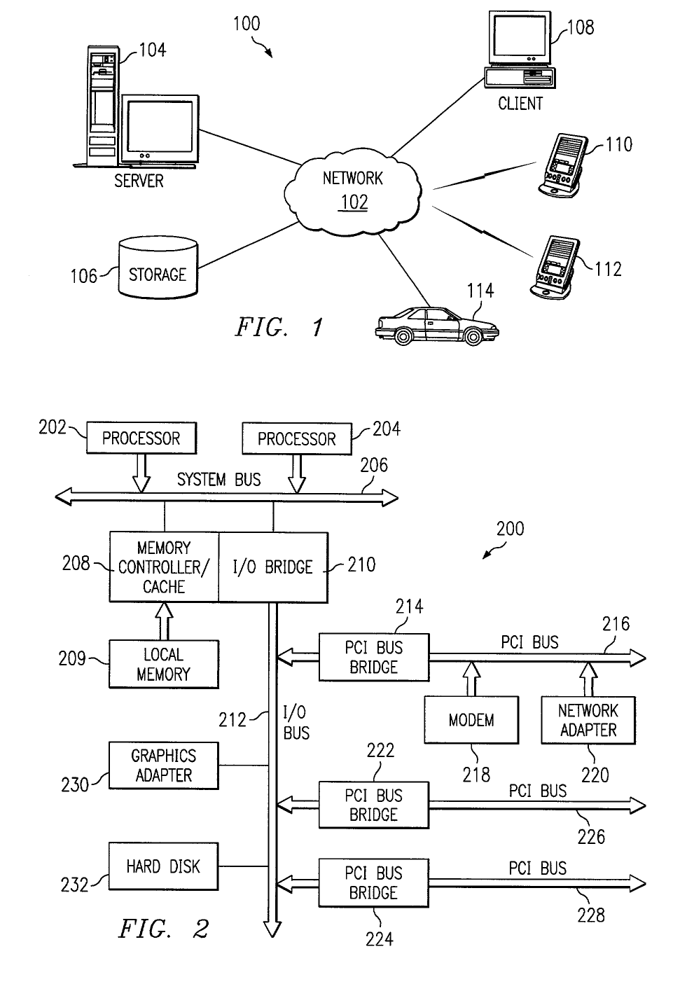

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, 112, and 114 are in communication with network 102. In this example, client 108 may be, for example, a personal computer or a network computer. Clients 110, 112, and 114 represent pervasive computing devices. In these examples, client 110 and client 112 are personal digital assistants (PDA), while client 114 is an auto PC. Pervasive computing devices provide mobile, anyplace, anytime access to networks and applications. Other pervasive computing devices may communicate with network 102, such as a digital phone, Web pads, internet access devices, and intelligent appliances. In these examples, client 108 is connected to network 102 by a physical connection while clients 110, 112, and 114 communicate with network 102 through a wireless connection.

In the depicted example, server 104 provides data, such as boot files, operating system images, and applications to clients 108-114. Clients 108, 110, 112, and 114 are clients to server 104. Server 104 may include server processes, such as, for example, a Web server and a mail server. Specifically, the mail server may be a POP3 mail server from which clients 108-114 may access electronic mail messages.

Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Specifically, data processing system 200 may include instructions for a POP3 server process.

Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bridge 210 is connected to system bus 206 and provides an interface to I/O bus 212. Memory controller/cache 208 and I/O bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-114 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

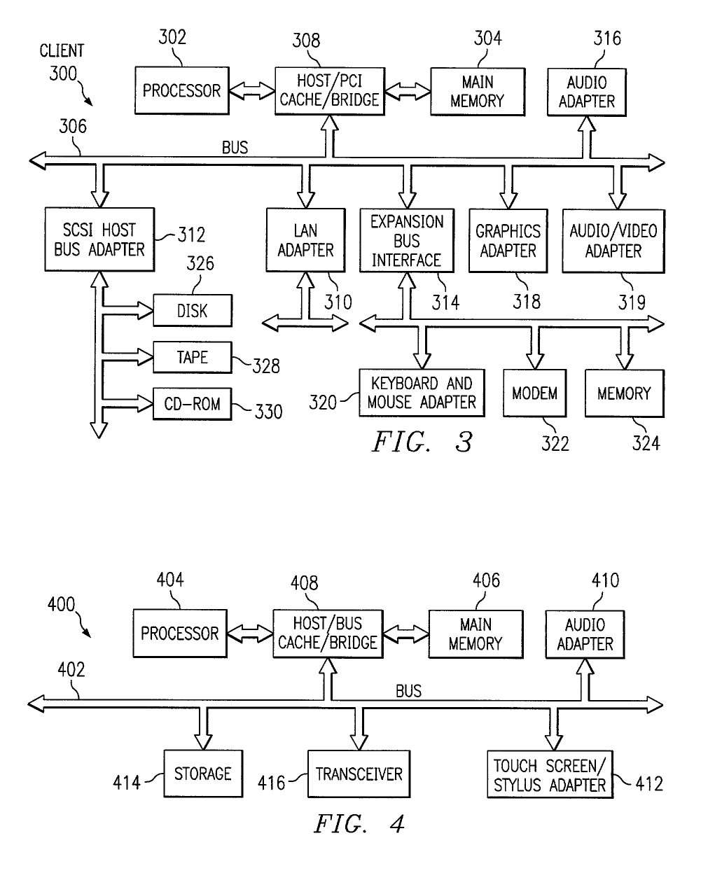

With reference now to FIG. 3, a block diagram illustrating a data processing system is depicted in which the present invention may be implemented. Data processing system 300 is an example of a client computer, such as client 108 in FIG. 1. Additionally, the components illustrated in FIG. 2 may be used to implement an auto PC, such as client 114 in FIG. 1.

Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. Instructions for the operating system and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface.

The depicted example in FIG. 3 and above-described examples are not meant to imply architectural limitations. For example, data processing system 300 also may be a notebook computer or hand held computer. Data processing system 300 also may be a kiosk or a Web appliance.

Turning now to FIG. 4, a block diagram of a personal digital assistant (PDA) is shown in accordance with a preferred embodiment of the present invention. PDA 400 is an example of a PDA, such as client 110 or 112 in FIG. 1, in which code or instructions implementing the processes of the present invention may be located. PDA 400 includes a bus 402 to which processor 404 and main memory 406 are connected to bus 402 by host/bus cache/bridge 408. Audio adapter 410 allows for sound to be presented to the user in PDA 400. Touch screen/stylus adapter 412 allows for presentation of a graphical user interface to the user as well as providing an interface for the user to input data and commands. Information such as calendars, address books, and electronic mail may be stored within storage 414. Additionally, instructions for programs, such as a mail program, may be stored within storage 414. Storage 414 may take various forms, such as a random access memory, a read-only memory, or a flash memory. The memory may be built into PDA 400 or take the form of a removable memory, such as a flash card or a memory stick.

The operating system may be, for example, a commercially available operating system such as Windows CE, which is available from Microsoft Corporation. Instructions for the operating system and applications or programs located on storage devices, such as storage 414, may be loaded into main memory 406 for execution by processor 404.

The present invention provides an improved method, apparatus, and computer instructions to provide post office protocol 3 (POP3) mail server support in an Internet messaging access protocol (IMAP) manner to provide the advantages of an IMAP mail system using a POP3 system.

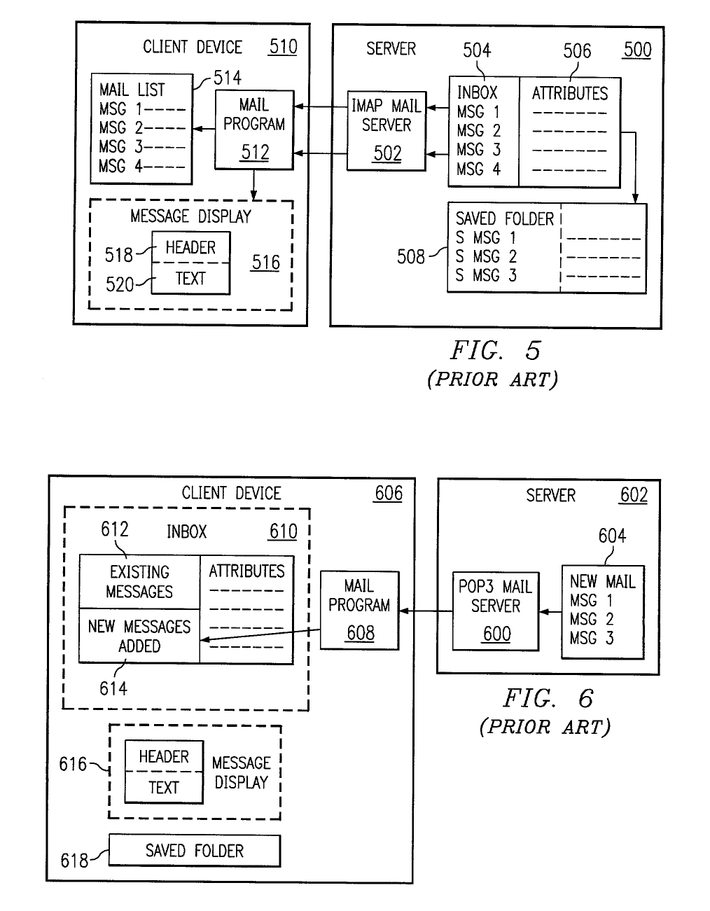

Turning next to FIG. 5, a diagram of a known Internet messaging access protocol (IMAP) system is depicted. Server data processing system 500 is a computer executing processes for IMAP mail server 502. IMAP mail server 502 maintains mail inbox 504 along with attributes 506 for each electronic mail message. In these examples, attributes include flags for “seen”/“unseen”, deleted, and answered electronic mail messages. Other attributes include, for example, priority, recent, and dates. Saved mail folder 508 also is kept on server data processing system 500 and has a similar structure to the mail inbox 504.

On the client side, client device 510 executes mail program 512 to present mail list 514 to a user. Mail inbox 504 is accessed through IMAP mail server 502 to access and collect information from the headers of electronic mail messages stored in mail inbox 504. This information is presented in mail list 514 in client device 510. This information is collected and presented each time the mail list 514 is refreshed. When an individual electronic mail message is selected from mail list 514 for display, that electronic mail message is retrieved from mail inbox 504 and presented to the user, as illustrated by message display 516, which presents header information 518 and text 520 to the user.

With reference next to FIG. 6, a diagram illustrating a known post office protocol 3 (POP3) electronic mail system is illustrated. POP3 mail server 600 is executing on server data processing system 602. POP3 mail server 600 receives new mail 604 and passes this new mail along to client device 606. New mail 604 is a set of one or more electronic mail messages. These electronic mail messages are received from POP3 mail server 600 through mail program 608 in client device 606 whenever inbox 610 is refreshed.

In this example, inbox 610 contains existing messages 612, as well as new messages 614. Inbox 610 actually contains electronic mail messages as opposed to being a display of messages in a mail list, such as mail list 514 in FIG. 5. As can be seen, with a POP3 electronic mail system, messages are stored in client device 606, as opposed to on the server as with the IMAP system depicted in FIG. 5.

When electronic mail messages in new mail 604 are copied from server data processing system 602 to client device 606, these electronic mail messages in new mail 604 are deleted by default from the server. Such a deletion is a configurable option at the client. When the user displays an electronic mail message on message display 616, the electronic mail message is accessed from the local inbox, inbox 610, on client device 606. When an electronic mail message is “saved”, this message is moved from inbox 610 to saved folder 618 on client device 606. POP3 systems currently do not provide the capability of defining additional folders on the server. As a result, the saved folder or any others must be kept in local storage on the client device 606. This requirement further stresses the limited local storage resource on the Internet devices, such as PDAs and digital phones. Electronic mail messages containing attachments further consume the limited storage resources on these types of devices. The mechanism of the present invention provides an ability to use existing POP3 server systems while providing advantages associated with IMAP server systems.

Turning next to FIG. 7, a diagram of an improved POP3 electronic mail system is depicted in accordance with a preferred embodiment of the present invention. As illustrated in FIG. 7, no changes are necessary with respect to POP3 mail server 700 on server data processing system 702.

This new POP3 system elects to keep mail on the server data processing system 702 by configuring POP3 mail server 700 to “not” delete the electronic mail message upon receipt and by “not” copying the messages to the local storage on client device 704 from inbox 706 on server data processing system 702. Preventing deletion of messages on a server is achieved via a configuration setting telling the client to not delete messages that are retrieved, and simply by the client not copying retrieved messages to local storage that is not creating a local mail inbox folder. Client device 704 may be, for example, a PDA, such as PDA 400 in FIG. 4, or some other data processing system or pervasive computing device. No local inbox is present on client device 704, which is similar to IMAP. Instead, mail list 708 in client device 704 is an interface illustrating header information for mail list messages displayed in mail list 708. More specifically, mail list 708 is similar to mail list 514 in FIG. 5, rather than using inbox 610 in FIG. 6.

This arrangement results in all incoming mail messages residing on the server as opposed to the client. Message headers are retrieved by mail program 710 by requesting this header information from POP3 mail server 700 on server data processing system 702 upon connection to POP3 mail server 700 or upon refresh of mail list 708. This list information is displayed in mail list 708. >Message headers are retrieved from POP3 mail server 700 by mail program 710 using the POP3 command “TOP”. This POP3 command and other POP3 commands are those commands currently available with POP3 servers. These commands are issued as part of the process in mail program 710 in response to various user input, such as refreshing mail list 708.

Individual electronic mail messages are retrieved when and if the user selects an electronic mail message from mail list 708 for display. This retrieval includes any and all attachments because neither the message text nor the attachments, or for that matter the message headers, remain on the client permanently unless specifically saved by the user. Electronic mail messages are retrieved from POP3 mail server 700 for display in message display 712 using the POP3 command “RETR”. Header 714 and body 716 are displayed in message display 712 in these examples.

Of course, depending on the particular implementation, caching can be used as local storage permits, to prevent having to retrieve header or message contents from the server multiple times. With caching, once an electronic message is retrieved from POP3 mail server 700, it may be retrieved later from the cache rather than the server. When mail list 708 is refreshed the headers of all mail messages are cached at that time. The individual messages may or may not be cached at mail list refresh time.

The header information from these electronic mail messages is used to generate the display of mail list 708. When mail program 710 is terminated or turned off, this cached information may then be discarded. As a result, limited storage resources on client device 704 are not used up as with normal POP3 mail systems. The next time the mail program is turned on, the header information is again retrieved from the server to generate a current display for mail list 708. The option of retaining messages on the server is used to allow for this header information to be retrieved at a later time. Further, in this example, mail list 708 does not include the entire headers; only the fields that are to be presented to the user are used by mail list 708.

Also shown in FIG. 7 is a bookkeeping file, mail attribute file 718, that is created on the client to store per message attributes, such as attributes 506 described with respect to FIG. 5. These attributes include, for example, a flag to indicate which messages have been viewed (“read/unread”), a flag to identify electronic mail messages selected for deletion, and a flag to identify replies that have been made to received electronic mail messages. The attributes are stored in mail attribute file 718 on client device 704 because POP3 mail server 700 does not provide these attributes on the server as with an IMAP mail server. This file is resynched with the server each time the incoming mailbox is accessed by mail program 710. Mail attribute file 718 also is updated on each mail operation on the client. These operations include display, delete, and save. Electronic mail messages are deleted from the POP3 server using the POP3 command “DELE”, and messages are also deleted from the server when they are saved at the client.

With reference next to FIG. 8, a diagram of an entry in a mail attribute file is depicted in accordance with a preferred embodiment of the present invention. As illustrated in FIG. 8, each entry in the mail attribute file 718 includes unique ID (UID) 800 of the message and attribute 802. UIDs are retrieved from the POP3 server using the POP3 command “UID”. The use of mail attribute file 718 allows for a “read/unread” indicator to be displayed in mail list 708 and an unread mail count that can be displayed along with the mail list 708. In addition, the stored UID values are used to recognize the arrival of more recent messages than those that are already represented in the mail list and therefore in the mail attribute file. This allows the setting of a “New Mail” indicator, such as an LED or special icon. This information is readily available in the IMAP protocol from the server, but not with POP3 because each new connection to the server appears to be retrieving “new” mail. In these examples, mail attribute file 718 is designed to be as small as possible because this file takes up space on the local client storage in client device 704. Mail attribute file 718 may allocate a few bytes for each electronic mail message.

POP3 mail systems also have a limitation of not being able to specify additional folders on the server. This limitation prevents the creation of named folders, such as a saved mail folder, as is available in the IMAP protocol. This limitation is addressed in a preferred embodiment of the present invention by creating additional folders in local storage on the client device as is done in traditional POP3 email clients. However, in order to optimize the use of local storage in this limited environment, a filtering mechanism, filter 720, is placed between the inbox on the server and the local mail folder on the client. This mechanism allows the user to view any attachments initially and for as long as the mail message is kept in inbox 706 on server data processing system 702.

By using filter 720, the user also can decide which attachments to preserve when moving a mail message to a local folder, such as saved folder 722. The filtering is not tied to the server configuration in these examples. This system allows the filtering decision to be made on a per message basis rather than the general type of attachments. Of course, parameters, such as file size and file type, may be used to filter attachments along with the filtering performed on a per message basis. In these examples, the local storage size limit is a configurable option and the user maintains control over which attachments, if any, to store in saved folder 722. Further, only messages with attachments are subject to filtering.

With this mail system, saved folder 722 is the largest potential user of the local client storage on client device 704. Saving attachments from electronic mail messages can severely limit the number of messages allowed in the local folders, such as saved folder 722, on client device 704.

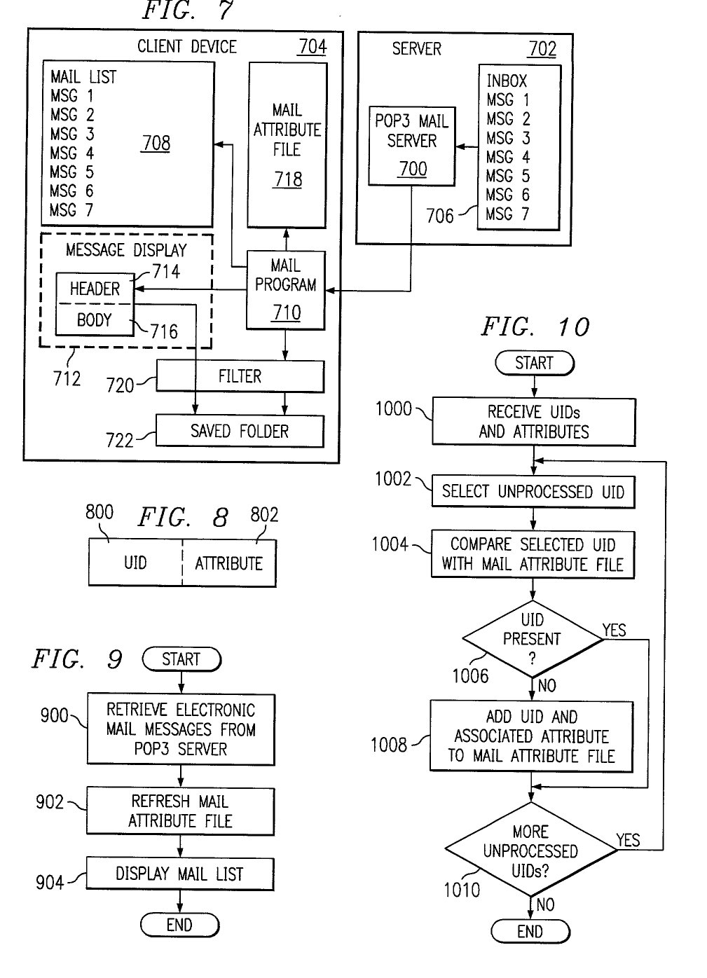

With reference now to FIG. 9, a flowchart of a process used retrieving electronic mail messages is depicted in accordance with a preferred embodiment of the present invention. The steps illustrated in FIG. 9 may be implemented using computer or processor instructions in a mail program, such as mail program 710 in FIG. 7.

The process begins by retrieving electronic mail messages from the POP3 server (step 900). The retrieval of these messages may involve retrieving only the header information or all of the messages and pre-caching the messages at the client device. The mail attribute file is refreshed (step 902). The mail attribute file is refreshed to update the file to reflect information from new messages retrieved from the POP3 mail server. This step is described in more detail with respect to FIG. 10 below. The mail list is displayed (step 904) and the process terminates thereafter. The mail list is similar to mail list 708 in FIG. 7 and includes a list of electronic mail messages received for the mail account.

Turning next to FIG. 10, a flowchart of a process used for updating a mail attribute file is depicted in accordance with a preferred embodiment of the present invention. The process illustrated in FIG. 10 may be implemented using computer or processor instructions in a mail program, such as mail program 710 in FIG. 7.

The process begins by retrieving UIDs and attributes (step 1000). An unprocessed UID is selected (step 1002). The selected UID is compared with the mail attribute file (step 1004).

Next, a determination is made as to whether the UID is present in the mail attribute file (step 1006). If the UID is absent, the UID and associated attribute or attributes are added to the mail attribute file (step 1008). Next, a determination is made as to whether more unprocessed UIDs are present. If more unprocessed UIDs are present, the process returns to step 1002. Otherwise, the process terminates. Returning to step 1006, if the UID is present in the mail attribute file, the process proceeds to step 1010, as described above.

The present invention also provides a mechanism to allow for the use of multiple mail accounts on a client device. Currently, local files and folders for electronic mail messages are not placed in a shared directory and are tied only to a user name on a client device. In order to enable the sharing of mail accounts in a multi-user environment, these files are assigned to a shared directory path on a client device. The directory path uses the following format:

/mail server system name/mail account name/

For example, the following may be a path for shared mail accounts:

/shared/email/pop3.austin.ibm.com/bilansky/

The mail account name is the user name created on the server.

Previously, the local files and folders related to mail were not kept in a shared directory, and were tied only to the user name on the device. One or more user IDs on the device can be configured to use the same mail account on the server if desired. If this is the case, these IDs share one copy of the saved folder and the mail attribute file. If the users each configure their own mail account, then each user will have their own set of files, since their path would be different for mail account names.

Either of the sharing users that log onto the device have the same view of the mail stored in the inbox on the server and the same view of the saved folder on the client. However the users will have separate identities for other aspects of electronic mail messages, such as a separate address book and a separate full name (the name placed in the from field of outgoing mail), and also a separate drafts folder (unfinished mail to be sent later). These aspects are all tied to the user ID on the client as opposed to the mail account on the server.

With multiple users sharing a client, each user may have their own saved file and attribute file by appending the client side user ID to the directory path. This path would have the following form:

/mail server system name/mail account name/Client Userid/.

For example, the path may be as follows:

/shared/email/pop3.austin.ibm.com/bilansky/mbilansky/

This configuration would allow more uniqueness to each of the sharing users, such as their own read/unread status, but would require the use of more local storage. The sharing of mail accounts among client device users is optional. Each user on the device may configure their own mail account on any available server, POP3 or IMAP.

Further, the POP3 mail system of the present invention also lends itself to the sharing of mail accounts from different systems. Since the inbox resides on the POP3 mail server, a user may access the inbox from a device at work or from another device at home. With this implementation, each of the Internet devices will have their own attributes file and saved folder. With the extension of multiple users on these devices, the local saved folder is also placed in a shared directory, created for each mail server and account being used. This configuration allows multiple users to share the same mail account if desired, without paying the local storage penalty of multiple copies of the local saved folder or the bookkeeping file of course, users still have the option of individual email accounts and the associated mail folders and files.

Thus, the present invention provides an improved method, apparatus, and computer instructions for providing POP3 server support in client devices. This mechanism is especially useful for client devices with limited storage. The mechanism of the present invention provides the advantages of an IMAP mail system through a POP3 mail system. The mechanism does not require any changes to currently used POP3 mail systems. Instead, changes and additions are implemented in the mail program on the client device. As a result, client devices with limited storage may have a wider range of electronic mail options with an ability to use both IMAP and POP3 systems.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for managing electronic mail messages from a post office protocol 3 server, the method comprising:
retrieving header information for electronic messages on the post office protocol 3 server to form retrieved header information;
updating an attribute file, wherein the attribute file includes an indication of whether an electronic mail message has been read;
presenting a mail list on a display using the retrieved header information and the attribute file; and
responsive to a selection of an electronic mail message from the mail list, retrieving and presenting the electronic mail message.

2. The method of claim 1, wherein the electronic mail message is retrieved from the post office protocol 3 server.

3. The method of claim 1, wherein the electronic mail message is retrieved from a cache on the data processing system.

4. The method of claim 1, wherein the step of retrieving the header information retrieves only the header information from the post office protocol 3 server.

5. The method of claim 1, wherein the step of retrieving the header information comprises retrieving all parts of the electronic message from the post office protocol 3 server.

6. The method of claim 1, wherein the electronic mail message includes an attachment and further comprising:
responsive to a user request to save the electronic mail message, filtering the message to selectively save the attachment on the data processing system.

7. The method of claim 6, wherein the filtering step comprises:
prompting for a user input as to whether the attachment is to be saved; and
saving the attachment along with the electronic mail message if the user input indicates that the attachment is to be saved.

8. The method of claim 6, wherein the filtering step comprises:
comparing the attachment with criteria to form a comparison;
saving the attachment based on the comparison.

9. The method of claim 8, wherein the criteria includes at least one of a file size of the attachment and a file type of the attachment.

10. A method for sharing a mail account from a post office protocol 3 server with a plurality of users having at least one computing device having limited storage amongst the plurality of users, the method comprising:
retrieving portions of incoming mail in storage in a mail inbox at the post office protocol 3 server, wherein the incoming mail is kept in storage in the mail box at the post office protocol 3 server;
presenting a mail list using the portions of incoming mail retrieved from the mailbox at the post office protocol 3 server;
retrieving, from the post office protocol 3 server, individual messages from the mail inbox at the post office protocol 3 server if one of the users selects a message for display; and
filtering the message from the individual messages to a folder in a shared directory in the local storage in response to a user request to save the message, wherein the shared directory is shared by each user sharing the mail account.

11. The method of claim 10 further comprising:
creating a bookkeeping file at the at least one computing device, wherein the bookkeeping file indicates which messages have been viewed and which messages have been deleted; and
resyncing the bookkeeping file at a given computing device each time the incoming mail is accessed and for each mail operation at the at least one computing device.

12. The method of claim 10, wherein the filtering step includes:
prompting for a user input as to whether an attachment associated with the message should be saved;
receiving the user input in response to prompting for the user input to form a received user input; and
selectively saving the attachment associated with the message based on the received user input.

13. The method of claim 10 further comprising:
retrieving message headers from the post office protocol 3 server upon connection of the at least one computing device to the post office protocol 3 server; and
displaying a list of the message headers at the at least one computing device.

14. The method of claim 10, wherein each user has a folder in the shared directory.

15. The method of claim 10, wherein the incoming mail is kept in the storage at the post office protocol 3 server using a configurable option for the post office protocol 3 client.

16. A data processing system for managing electronic mail messages from a post office protocol 3 server, the data processing system comprising:
a bus system;
a communications unit connected to the bus system;
a memory connected to the bus system, wherein the memory includes a set of instructions; and
a processing unit connected to the bus system, wherein the processing unit executes the set of instructions to retrieve header information for electronic messages on the post office protocol 3 server to form retrieved header information; update an attribute file in which the attribute file includes an indication of whether an electronic mail message has been read; present a mail list on a display using the retrieved header information and the attribute file; and retrieve and present the electronic mail message in response to a selection of an electronic mail message from the mail list.

17. A data processing system for sharing a mail account from a post office protocol 3 server with a plurality of users having at least one computing device having limited storage amongst the plurality of users, the data processing system comprising:
a bus system;
a communications unit connected to the bus system;
a memory connected to the bus system, wherein the memory includes a set of instructions; and
a processing unit connected to the bus system, wherein the processing unit executes the set of instructions to retrieve portions of incoming mail in storage in a mail inbox at the post office protocol 3 server in which the incoming mail is kept in storage in the mail box at the post office protocol 3 server; present a mail list using the portions of incoming mail retrieved from the mailbox at the post office protocol 3 server; retrieve, from the post office protocol 3 server, individual messages from the mail inbox at the post office protocol 3 server if one of the users selects a message for display; and filter the message from the individual messages to a folder in a shared directory in the local storage in response to a user request to save the message in which the shared directory is shared by each user sharing the mail account.

18. A data processing system for managing electronic mail messages from a post office protocol 3 server, the data processing system comprising:
first retrieving means for retrieving header information for electronic messages on the post office protocol 3 server to form retrieved header information;
updating means for updating an attribute file, wherein the attribute file includes an indication of whether an electronic mail message has been read;
presenting means for presenting a mail list on a display using the retrieved header information and the attribute file; and
second retrieving means and second presenting means, responsive to a selection of an electronic mail message from the mail list, for retrieving and presenting the electronic mail message.

19. The data processing system of claim 18, wherein the electronic mail message is retrieved from the post office protocol 3 server.

20. The data processing system of claim 18, wherein the electronic mail message is retrieved from a cache on the data processing system.

21. The data processing system of claim 18, wherein the retrieving means for retrieving the header information retrieves only the header information from the post office protocol 3 server.

22. The data processing system of claim 18, wherein the retrieving means for retrieving the header information comprises means for retrieving all parts of the electronic message from the post office protocol 3 server.

23. The data processing system of claim 18, wherein the electronic mail message includes an attachment and further comprising:
filtering means, responsive to a user request to save the electronic mail message, for filtering the message to selectively save the attachment on the data processing system.

24. The data processing system of claim 23, wherein the filtering means comprises:
prompting means for prompting for a user input as to whether the attachment is to be saved; and
saving means for saving the attachment along with the electronic mail message if the user input indicates that the attachment is to be saved.

25. The data processing system of claim 23, wherein the filtering means comprises:
comparing means for comparing the attachment with criteria to form a comparison;
saving means for saving the attachment based on the comparison.

26. The data processing system of claim 25, wherein the criteria includes at least one of a file size of the attachment and a file type of the attachment.

27. A data processing system for sharing a mail account from a post office protocol 3 server with a plurality of users having at least one computing device having limited storage amongst the plurality of users, the data processing system comprising:
first retrieving means for retrieving portions of incoming mail in storage in a mail inbox at the post office protocol 3 server in which the incoming mail is kept in storage in the mail box at the post office protocol 3 server;
first presenting means for presenting a mail list using the portions of incoming mail retrieved from the mailbox at the post office protocol 3 server;
second retrieving means for retrieving, from the post office protocol 3 server, individual messages from the mail inbox at the post office protocol 3 server if one of the users selects a message for display; and
filtering means for filtering the message from the individual messages to a folder in a shared directory in the local storage in response to a user request to save the message in which the shared directory is shared by each user sharing the mail account.

28. The data processing system of claim 27, wherein the creating means is a first creating means and further comprising:
second creating means for creating a bookkeeping file at the at least one computing device, wherein the bookkeeping file indicates which messages have been viewed and which messages have been deleted; and
resyncing means for resyncing the bookkeeping file at a given computing device each time the incoming mail is accessed and for each mail operation at the at least one computing device.

29. The data processing system of claim 27, wherein the filtering means includes:
prompting means for prompting for a user input as to whether an attachment associated with the message should be saved;
receiving means for receiving the user input in response to prompting for the user input to form a received user input; and
saving means for selectively saving the attachment associated with the message based on the received user input.

30. The data processing system of claim 27, wherein the retrieving means is a first retrieving means and further comprising:
second retrieving means for retrieving message headers from the post office protocol 3 server upon connection of the at least one computing device to the post office protocol 3 server; and
displaying means for displaying a list of the message headers at the at least one computing device.

31. The data processing system of claim 27, wherein each user has a folder in the shared directory.

32. The data processing system of claim 27, wherein the incoming mail is kept in the storage at the post office protocol 3 server using a configurable option for the post office protocol 3 client.

33. A computer program product in a computer readable medium for managing electronic mail messages from a post office protocol 3 server, the computer program product comprising:
first instructions for retrieving header information for electronic messages on the post office protocol 3 server to form retrieved header information;
second instructions for updating an attribute file, wherein the attribute file includes an indication of whether an electronic mail message has been read;
third instructions for presenting a mail list on a display using the retrieved header information and the attribute file; and
fourth instructions, responsive to a selection of an electronic mail message from the mail list, for retrieving and presenting the electronic mail message.

34. A computer program product in a computer readable medium for sharing a mail account from a post office protocol 3 server with a plurality of users having at least one computing device having limited storage amongst the plurality of users, the computer program product comprising:
first instructions for retrieving portions of incoming mail in storage in a mail inbox at the post office protocol 3 server, wherein the incoming mail is kept in storage in the mail box at the post office protocol 3 server;
second instructions for presenting a mail list using the portions of incoming mail retrieved from the mailbox at the post office protocol 3 server;
third instructions for retrieving, from the post office protocol 3 server, individual messages from the mail inbox at the post office protocol 3 server if one of the users selects a message for display; and
fourth instructions for filtering the message from the individual messages to a folder in a shared directory in the local storage in response to a user request to save the message, wherein the shared directory is shared by each user sharing the mail account.
